(19) United States
(12) Patent Application Publication
(10) Pub. No.: US 2026/0115640 A1
(43) Pub. Date: Apr. 30, 2026

(54) USER INTERFACE FOR AN AIR FILTRATION ASSEMBLY

(71) Applicant: Apex Brands, Inc., Apex, NC (US)

(72) Inventors: Ralf ZERWECK, Bönnigheim (DE); Michael MOHL, Freudental (DE)

(21) Appl. No.: 19/489,469

(22) PCT Filed: Apr. 30, 2024
(86) PCT No.: PCT/US2024/026998

§ 371 Date: Dec. 2, 2025

Related U.S. Application Data
(60) Provisional application No. 63/472,912, filed on Jun. 14, 2023.

(51) Int. Cl. B01D 46/44; B08B 13/00; B08B 15/04; B23K 3/08; G06F 3/042

(52) U.S. Cl. CPC B01D 46/44; B08B 13/00; B08B 15/04; B23K 3/08; G06F 3/042; B01D 2279/00

(57) ABSTRACT

An air filtration assembly for filtering gas or particles generated responsive to operation of the work tool may include an intake which may be repositionable relative to the work tool, a housing which may be operably coupled to the intake and may include a filter, a motor and processing circuitry, an exhaust operably coupled to the housing and a user interface via which a user may provide control signals to the processing circuitry. The processing circuitry may control an operating speed of the motor based on input received at the user interface. The user interface may include a projector module operably coupled to the processing circuitry to generate a display on a surface at or near a workstation at which the work tool may be operated.

### TECHNICAL FIELD

Example embodiments generally relate to air filtration assemblies and, in particular, relate to such assemblies having an improved user interface.

### BACKGROUND

Many tasks or processes that may commonly take place in manufacturing or lab settings may generate unwanted byproducts in various forms. For example, processes involving certain materials and chemicals may create waste that may need to be dealt with appropriately either via proper disposal or cleaning. In some cases, the byproducts may be airborne and may require the use of an air filtration assembly to dispose of them accordingly. One such task that may generate airborne byproducts may be soldering. Soldering tools, which are sometimes referred to as soldering irons or soldering guns, are commonly used in electronics manufacturing and repair activities along with other crafts and industries that involve metalwork. Soldering tools are typically used to join metallic items together at a joint by melting a filler metal (i.e., solder) into the joint. A tip portion of the soldering tool may, due to operation of a heater, become hot enough to melt solder that contacts the tip portion. The act of melting the solder, and thus soldering in general, may release gas into the air that may contain volatile organic compounds (VOC's) or other chemicals.

Soldering and other related tasks may often be performed at a workstation indoors. In some cases, the workstation may be located proximate to other workstations and sometimes within the same room. Thus, an air filtration assembly may be employed to filter the air proximate to the workstation where the task may be taking place. Common considerations to make regarding the configuration and use of the air filtration assembly may include ensuring it is adequately sized for the space it is occupying, ensuring it is operating effectively, and improving its overall ease of operation/user experience. Thus, it may be desirable to provide an improved air filtration assembly to address some of the above considerations to create an environment that may be safer for the operator and other potential surrounding workstations.

### BRIEF SUMMARY OF SOME EXAMPLES

In an example embodiment, an air filtration assembly for filtering gas or particles generated responsive to operation of the work tool may be provided. The air filtration assembly may include an intake which may be repositionable relative to the work tool, a housing which may be operably coupled to the intake and may include a filter, a motor and processing circuitry, an exhaust operably coupled to the housing and a user interface via which a user may provide control signals to the processing circuitry. The processing circuitry may control an operating speed of the motor based on input received at the user interface. The user interface may include a projector module operably coupled to the processing circuitry to generate a display on a surface at or near a workstation at which the work tool may be operated.

In another example embodiment, a work system may be provided. The work system may include a work tool, a workstation at which the work tool may perform a work task, and an air filtration assembly for filtering gas or particles generated responsive to operation of the work tool. The air filtration assembly may include an intake which may be repositionable relative to the work tool, a housing which may be operably coupled to the intake and may include a filter, a motor and processing circuitry, an exhaust operably coupled to the housing and a user interface via which a user may provide control signals to the processing circuitry. The processing circuitry may control an operating speed of the motor based on input received at the user interface. The user interface may include a projector module operably coupled to the processing circuitry to generate a display on a surface at or near a workstation at which the work tool may be operated.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a work system according to an example embodiment;

FIG. 2 illustrates a perspective view of the work system of FIG. 1 in accordance with an example embodiment;

FIG. 3 illustrates a perspective view of the work system of FIG. 1 in accordance with an example embodiment;

FIG. 4 illustrates a perspective view of the work system of FIG. 1 in accordance with an example embodiment;

FIG. 5 illustrates a perspective view of the work system of FIG. 1 in accordance with an example embodiment; and

FIG. 6 illustrates a perspective view of the work system of FIG. 1 in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of an air filtration assembly that includes features that improve its operation. In some cases, the air filtration assembly may include an improved user interface to make it easier to provide input commands to control the air filtration assembly. In this regard, the air filtration assembly may often be disposed either under a workstation or as a standalone unit disposed some distance away from the workstation. In such cases, having the user interface disposed on a housing of the air filtration assembly may make it difficult for the user to interact with from their position at the workstation using a work tool. Thus, in some embodiments, the user interface may be projected onto the floor or onto a work surface of the work station so that it may be more easily viewed and interacted with for a user working at the workstation. However, other strategies and features are also contemplated as described in greater detail below.

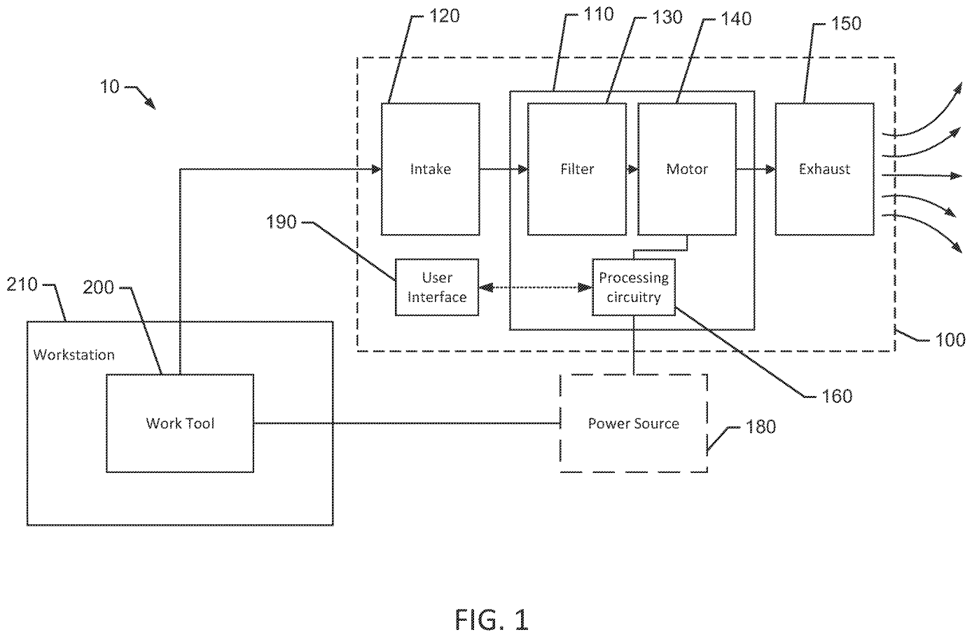

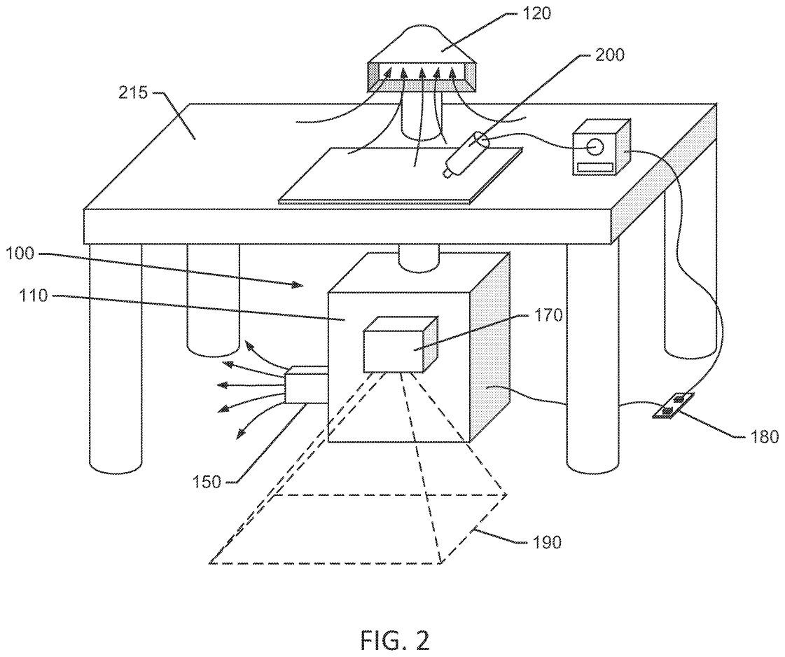

FIG. 1 illustrates a block diagram of a work system 10 according to an example embodiment. FIGS. 2-6 illustrate perspective views of the air filtration assembly 100 set up at a workstation 210 in accordance with example embodiments.

The work system 10 of FIG. 1 may include an air filtration assembly 100, a work tool 200 and a workstation 210. The air filtration assembly 100 of some embodiments may include a housing 110, an intake 120, a filter 130, a motor 140, an exhaust 150 and processing circuitry 160. In some cases, the housing 110 may contain the filter 130, the motor 140 and the processing circuitry 160 within the housing 110. The housing 110 may take on any number of shapes and sizes depending on various design constraints such as the volume of air that the air filtration assembly 100 may need to filter, or in what type of setting the air filtration assembly 100 may be used in. For example, in some cases the air filtration assembly 100 may be a relatively small assembly, and thus the housing 110 may be configured to be disposed on a desktop/workbench. In other cases the air filtration assembly 100 may be slightly larger and thus the housing 110 may be configured to be disposed under a desk/workbench. In another case, the air filtration assembly 100 may be even larger still and configured to be disposed nearby as a standalone assembly. Thus, the housing 110 may take on different shapes and/or sizes depending on the particular needs and configuration of each embodiment dictated by the environment and the particular use case of the air filtration assembly 100.

The housing 110 may also include the intake 120 and the exhaust 150 operably coupled thereto. In this regard, and as shown in FIG. 1, air may enter the air filtration assembly 100 through the intake 120 before proceeding to pass through the filter 130 responsive to the operation of the motor 140 driving a fan or other mechanism to facilitate airflow through the air filtration assembly 100. The air may exit the air filtration assembly 100 through the exhaust 150 where it may then reenter the immediate surrounding environment, or be directed elsewhere, responsive to having any airborne particles filtered out of the air by the filter 130. In some cases, the filter 130 may be a high efficiency particulate air (HEPA) filter. In some other cases, different levels/forms of filtration may be desired which may necessitate different types of filters for larger or smaller airborne particulates, and even some gaseous compounds.

The air filtration assembly 100 may be powered by a power source 180 which, according to an example embodiment, may be a source of electrical energy such as a battery or a connection to mains power. Operation of the air filtration assembly 100 may be controlled by the processing circuitry 160 which may be operably coupled to the power source 180 to control the delivery of power to the motor 140 accordingly. In this regard, the processing circuitry 160 may also be operably coupled to a user interface 190 that, in some cases, may be disposed at the housing 110. The user interface 190 may be operable by a user 195 to change certain operating parameters of the air filtration assembly 100, such as powering on/off the air filtration assembly 100 and changing an operating speed of the motor 140, among others. In some cases, the processing circuitry 160 may control the operation of the air filtration assembly 100 automatically responsive to input from one or more sensors operably coupled to the processing circuitry 160 and without input from the user interface 190. In another example embodiment, the processing circuitry 160 may operate the air filtration assembly 100 at a set operating speed for specific time intervals responsive to input at the user interface 190 of the user 195 selecting such a mode of operation.

The processing circuitry 160 may be configured to provide electronic control inputs to one or more functional units of the air filtration assembly 100 and to process data received at or generated by the one or more functional units of the air filtration assembly 100. Thus, the processing circuitry 160 may be configured to perform data processing, control function execution and/or other processing and management services according to an example embodiment. In some embodiments, the processing circuitry 160 may be embodied as a chip or chip set. In other words, the processing circuitry 160 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 160 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 160 may include one or more instances of a processor 162 and memory 164 that may be in communication with or otherwise control other components or modules that interface with the processing circuitry 160. As such, the processing circuitry 160 may be embodied as a circuit chip (e.g., an integrated circuit chip) configured (e.g., with hardware, software or a combination of hardware and software) to perform operations described herein. In some embodiments, the processing circuitry 160 may be embodied as a portion of an onboard computer housed in the housing 110 of the air filtration assembly 100 to control operation of the assembly.

FIGS. 1-5 also depict a work tool 200 and a workstation 210, which the air filtration assembly 100 may be operably coupled to and/or disposed proximate to. In this regard, the workstation 210 may be a table, desk, workbench or any other sort of structure with a work surface 215 at which a user 195 may perform a work task. In some cases, the workstation 210 may not include a structure at all, and may simply be a general work surface 215 at which the work tool 200 may be disposed. In this regard, the work surface 215 may be the floor or ground in some embodiments. The work tool 200 may be any number of a variety of tools depending on a task that is desired to be accomplished. For example, the work tool 200 may be a soldering tool, a laser cutting tool, a 3D printer, an injection molding tool, a mill, a lathe, a power saw or many other types of tools commonly used in manufacturing and engineering. For the purposes of illustration and explanation of the components and associated structures of the air filtration assembly 100, the work tool 200 may be a soldering tool.

In an example embodiment, the user interface 190 may not always be disposed at the housing 110. In some cases, the user interface 190 may instead be disposed at a personal electronic device of the user 195. In this regard, the user 195 may be able to configure the operation of the air filtration assembly 100 wirelessly from a personal electronic device such as a smart phone, a tablet, or a personal computer, any of which may act as the user interface 190 in such embodiments. The user interface 190 may be in communication (i.e. either wirelessly or by wire) with the processing circuitry 160 to receive an indication of a user 195 input at the user interface 190 and/or to provide an audible, visual, tactile or other output to the user 195. As such, the user interface 190 may include, for example, a display, one or more switches, lights, buttons or keys, speaker, and/or other input/output mechanisms. In some cases, the processing circuitry 160 may control the operating speed of the motor 140 based on input provided to the user interface 190 of the air filtration assembly 100.

According to the example embodiments depicted in FIGS. 2-5, the user interface 190 may include a projector module 170 which may generate a display away from the housing 110. In this regard, as mentioned above, the air filtration assembly 100 of some embodiments may be disposed under a work surface 215 of the work station 210, or even disposed some distance away from the workstation 210 entirely, due to constraints on space and size. Thus, in some cases, the user interface 190 disposed at the housing 110 of the air filtration assembly 100 may include a display that may be be difficult for the user 195 to see and interact with during operation of the work tool 200. To minimize the inconvenience to the user 195 of ceasing operation of the work tool 200 to crouch under the workstation 210, or walk away from the workstation 210, to see and interact with the user interface 190, the projector module 170 may allow the display to be projected closer to the user 195. In an example embodiment, the projector module 170 may be removably operably coupled to the air filtration assembly 100. In this regard, the air filtration assembly 100 may include a standard user interface 190 disposed at the housing 110. The projector module 170 may be configured to operably couple to the housing 110 and generate the display away from the housing 110. Thus, the projector module 170 may be added on to the air filtration assembly 100 at any time. In some cases, the air filtration assembly 100 may include the projector module 170 from the point of purchase.

In the embodiment depicted in FIG. 2, the air filtration assembly 100 may be of a medium size and the housing 110 may be disposed at the workstation 210 underneath the work surface 215. If, for example, the display were to be disposed on the housing 110, the user 195 would not be able to conveniently see the display and would instead have to crouch under the work surface 215 to see it. Therefore, the projector module 170 shown in FIG. 2 may generate the display on the floor out in front of both the housing 110 and perhaps also in front of the workstation 210, or onto any other suitable surface nearby, where it may be more easily visible to the user 195. The projector module 170 of some embodiments may include a projector bulb. In this regard, the projector bulb may cast the light that may generate the display away from the housing 110. In the embodiment depicted in FIG. 2, the projector module 170 may be fixedly operably coupled to the housing 110, and operably coupled to the processing circuitry 160. The projector module 170 may be hardwired to the processing circuitry 160 in some cases, and wirelessly operably coupled to the processing circuitry 160 in others. In either case, the processing circuitry 160 may be configured to show operating parameters of the air filtration assembly 100 at the display of the user interface 190 via the projector module 170. In some other cases, the projector module 170 may be removably operably coupled to the housing 110. In this regard, the projector housing 170 may be operably coupled to the processing circuitry 160 either wirelessly or by wire. In either case, the projector module 170 may be disposed at another location if so desired by the user 195. For example, the user 195 could move the projector module 170 from the housing 110 to the underside of the workstation 210 so that the display may be projected in a more convenient location for the specific scenario of the user 195. In some cases, the projector module 170 may also be customizable. In this regard, the projector module 170 may be customized to move a location of the display, to adjust a size of the display and to adjust a focus of the projector bulb. The projector bulb may even be configured to adjust its focus automatically in some cases. In an example embodiment, the projector module 170 may be may be powered by the power source 180 which, according to an example embodiment, may be a source of electrical energy such as a battery or a connection to mains power. In some cases, the projector module 170 may be operably coupled to the power source 180 via the processing circuitry 160.

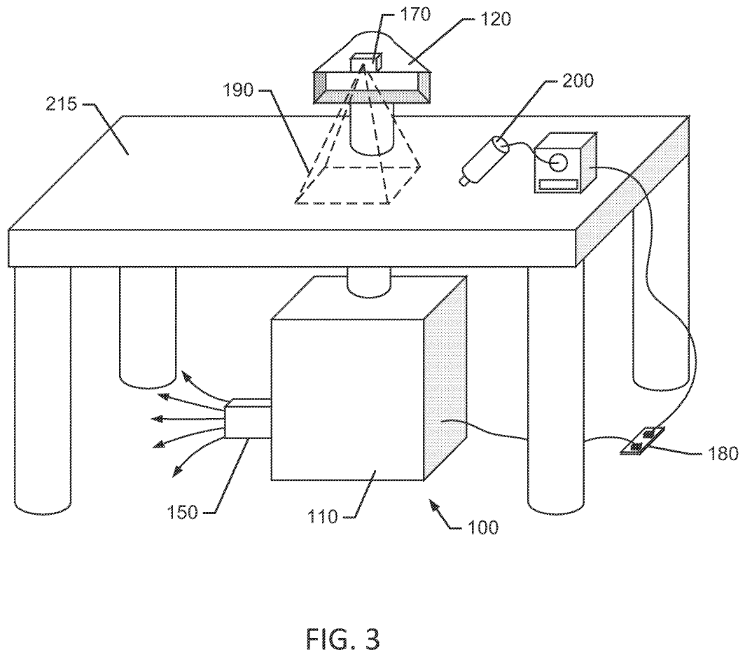

In the embodiment depicted in FIG. 3, again the air filtration assembly 100 may be of a medium size and the housing 110 may be disposed at the workstation 210 underneath the work surface 215. However, in contrast to the embodiment shown in FIG. 2, the projector module 170 of the embodiment shown in FIG. 3 may be disposed at the intake 120 of the air filtration assembly 100 and thus the projector module 170 may generate the display onto the work surface 215 where it may be more easily visible to the user 195. In this regard, the projector bulb may cast the light that may generate the display onto the work surface 215 proximate to where the user 195 may be operating the work tool 200 for increased convenience. In the embodiment depicted in FIG. 3, the projector module 170 may be fixedly operably coupled to the intake 120, and operably coupled to the processing circuitry 160. The projector module 170 may be hardwired to the processing circuitry 160 in some cases, and wirelessly operably coupled to the processing circuitry 160 in others. In either case, the processing circuitry 160 may be configured to show operating parameters of the air filtration assembly 100 at the display of the user interface 190 via the projector module 170. In some other cases, the projector module 170 may be removably operably coupled to the intake 120. In this regard, the projector housing 170 may be operably coupled to the processing circuitry 160 either wirelessly or by wire. In either case, the projector module 170 may be disposed at another location if so desired by the user 195. For example, the user 195 could move the projector module 170 from the intake 120 to an entirely separate structure, either on the work surface 215 or not, so that the display may be projected in a more convenient location for the specific scenario of the user 195. In some cases, the projector module 170 may also be customizable. In this regard, the projector module 170 may be customized to move a location of the display, to adjust a size of the display and to adjust a focus of the projector bulb. The projector bulb may even be configured to adjust its focus automatically in some cases. In an example embodiment, the projector module 170 may be may be powered by the power source 180 which, according to an example embodiment, may be a source of electrical energy such as a battery or a connection to mains power. In some cases, the projector module 170 may be operably coupled to the power source 180 via the processing circuitry 160.

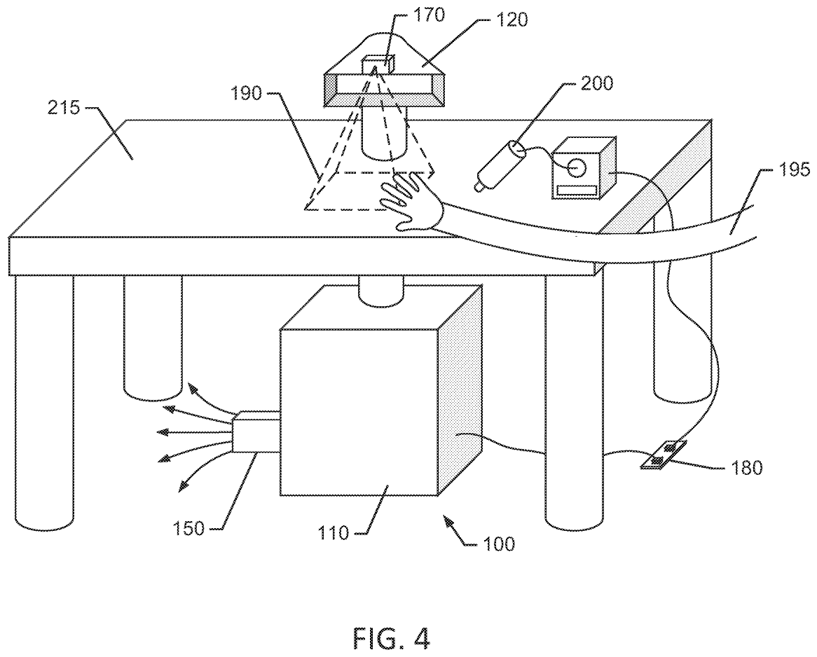

As shown in FIG. 4, in some cases, the display may be interactive so that the user interface 190 may still be operable by a user 195 to change certain operating parameters of the air filtration assembly 100, such as powering on/off the air filtration assembly 100 and changing an operating speed of the motor 140, among others. In such cases, the projector module 170 may further include an optical sensor, and the optical sensor may be configured to convey the interactions of the user 195 with the display to the processing circuitry 160 as control signals. For instance, the display may be projected onto the work surface 215 via the projector bulb in the projector module 170, as shown in FIG. 4. The user 195 may then “press” or indicate certain objects on the display, which may be tracked by the optical sensor in the projector module 170. The optical sensor may convey the pressing or indication of the objects on the display to the processing circuitry 160 as control signals which may use the control signals to change certain operating parameters of the air filtration assembly 100 accordingly. In some cases, the optical sensor may be a camera, an infrared sensor or other type of sensor capable of identifying and tracking movements of the user 195.

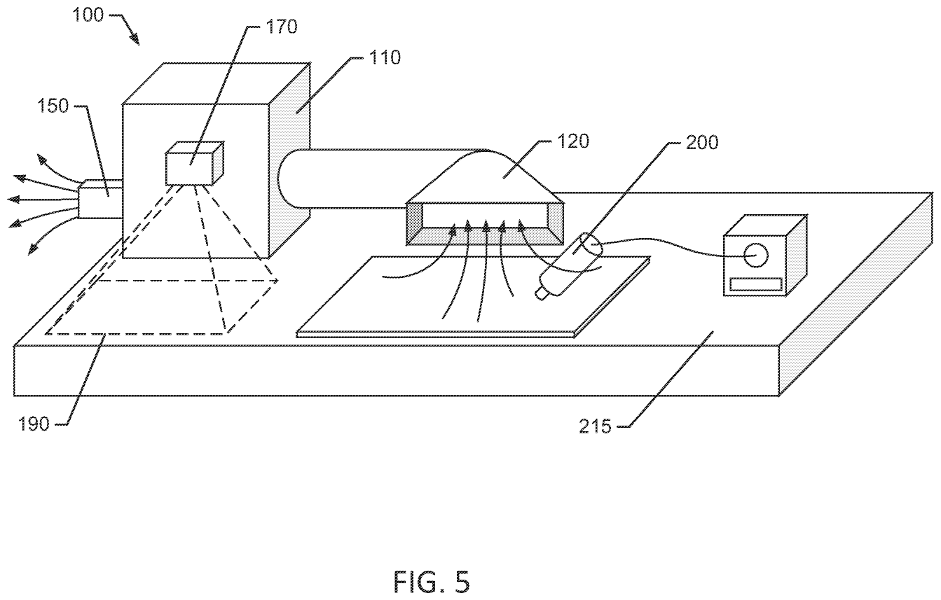

FIG. 5 depicts the air filtration assembly according to another example embodiment. In the embodiment depicted in FIG. 5, the air filtration assembly 100 may be of a small size and the housing 110 may be disposed at the workstation 210 on top of the work surface 215. The projector module 170 shown in FIG. 5 may generate the display onto the work surface 215 where it may be more easily visible to the user 195. Similar to the embodiment depicted in FIGS. 2-4, the display depicted in FIG. 5 may be customizable, interactive and movable as well. In other words, the projector module 170 described above in reference to FIGS. 2-4 above may be the same projector module 170 as shown in FIG. 5 implemented on a smaller air filtration assembly 100.

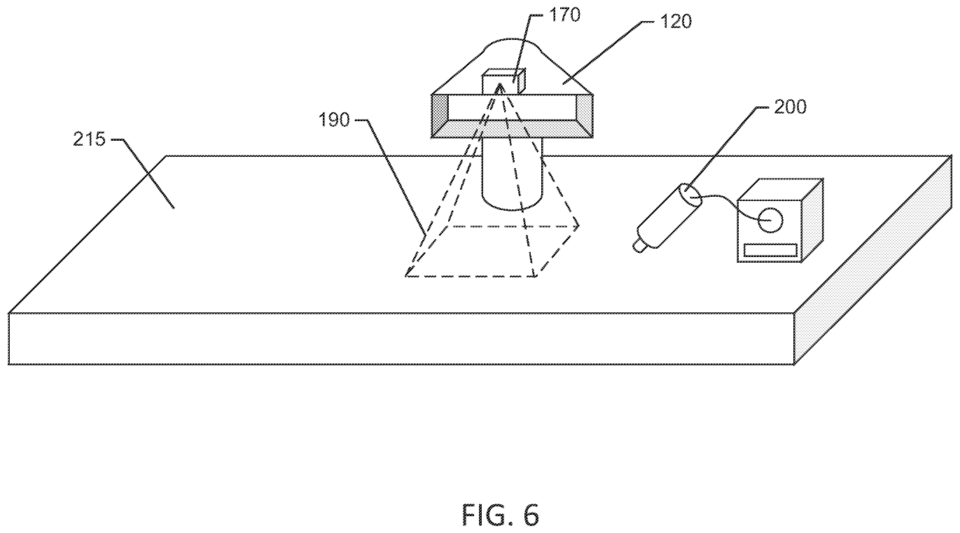

FIG. 6 depicts the air filtration assembly according to another example embodiment. In the embodiment depicted in FIG. 6, the air filtration assembly 100 may be of a large size and the housing 110 may be disposed away from the workstation 210 as a standalone unit (not pictured in FIG. 6). The projector module 170 shown in FIG. 6 may therefore be disposed at the intake 120, proximate to the user 195, and may generate the display at the work surface 215 where it may be more easily visible to the user 195. Similar to the embodiment depicted in FIGS. 2-5, the display depicted in FIG. 6 may be customizable, interactive and movable as well. In other words, the projector module 170 described above in reference to FIGS. 2-5 above may be the same projector module 170 as shown in FIG. 6 implemented on a larger air filtration assembly 100.

Some example embodiments may provide for an air filtration assembly for filtering gas or particles generated responsive to operation of the work tool. The air filtration assembly may include an intake which may be repositionable relative to the work tool, a housing which may be operably coupled to the intake and may include a filter, a motor and processing circuitry, an exhaust operably coupled to the housing and a user interface via which a user may provide control signals to the processing circuitry. The processing circuitry may control an operating speed of the motor based on input received at the user interface. The user interface may include a projector module operably coupled to the processing circuitry to generate a display on a surface at or near a workstation at which the work tool may be operated.

In some cases, the air filtration assembly described above may be augmented or modified by altering individual features mentioned above or adding optional features. The augmentations or modifications may be performed in any combination and in any order. For example, in some cases, the projector module may include a projector bulb and may be removably operably coupled to the air filtration assembly. In an example embodiment, the projector module may be operably coupled to the housing and may generate the display on a floor below the workstation via the projector bulb. In some cases, the projector module may be operably coupled to the housing and may generate the display on a work surface of the workstation via the projector bulb. In an example embodiment, the projector module may be disposed at the intake of the air filtration assembly. In some cases, the projector module may generate the display on a work surface of the workstation via the projector bulb. In an example embodiment, the projector module may further include an optical sensor. In some cases, the display may be interactive and the optical sensor may convey the user's interactions with the display to the processing circuitry as the control signals. In an example embodiment, the work tool may be a soldering tool. In some cases, the focus of the projector bulb may be adjusted automatically. In an example embodiment, the projector module may be customizable to move a location of the display, to adjust a size of the display and to adjust a focus of the projector bulb.

Some example embodiments may provide for a work system. The work system may include a work tool, a workstation at which the work tool may perform a work task, and an air filtration assembly for filtering gas or particles generated responsive to operation of the work tool. The air filtration assembly may include an intake which may be repositionable relative to the work tool, a housing which may be operably coupled to the intake and may include a filter, a motor and processing circuitry, an exhaust operably coupled to the housing and a user interface via which a user may provide control signals to the processing circuitry. The processing circuitry may control an operating speed of the motor based on input received at the user interface. The user interface may include a projector module operably coupled to the processing circuitry to generate a display on a surface at or near a workstation at which the work tool may be operated.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An air filtration assembly for filtering gas or particles generated responsive to operation of a work tool, the air filtration assembly comprising:
an intake repositionable relative to the work tool;
a housing operably coupled to the intake, the housing comprising a filter, a motor and processing circuitry;
an exhaust operably coupled to the housing; and
a user interface via which a user provides control signals to the processing circuitry,
wherein the processing circuitry controls an operating speed of the motor based on input received at the user interface, and
wherein the user interface comprises a projector module operably coupled to the processing circuitry to generate a display on a surface at or near a workstation at which the work tool is operated.

2. The air filtration assembly of claim 1, wherein the projector module comprises a projector bulb and is removably operably coupled to the air filtration assembly.

3. The air filtration assembly of claim 2, wherein the projector module is operably coupled to the housing and generates the display on a floor below the workstation via the projector bulb.

4. The air filtration assembly of claim 2, wherein the projector module is operably coupled to the housing and generates the display on a work surface of the workstation via the projector bulb.

5. The air filtration assembly of claim 2, wherein the projector module is disposed at the intake of the air filtration assembly.

6. The air filtration assembly of claim 5, wherein the projector module generates the display on a work surface of the workstation via the projector bulb.

7. The air filtration assembly of claim 2, wherein the projector module further comprises an optical sensor.

8. The air filtration assembly of claim 7, wherein the display is interactive and the optical sensor conveys the user's interactions with the display to the processing circuitry as the control signals.

9. The air filtration assembly of claim 2, wherein the projector module is customizable to move a location of the display, to adjust a size of the display and to adjust a focus of the projector bulb.

10. The air filtration assembly of claim 1, wherein the work tool is a soldering tool.

11. A work system comprising:
a work tool;
a workstation at which the work tool performs a work task; and
an air filtration assembly for filtering gas or particles generated responsive to operation of the work tool, the air filtration assembly comprising:
an intake repositionable relative to the work tool;
a housing operably coupled to the intake, the housing comprising a filter, a motor and processing circuitry;
an exhaust operably coupled to the housing; and
a user interface via which a user provides control signals to the processing circuitry,
wherein the processing circuitry controls an operating speed of the motor based on input received at the user interface, and
wherein the user interface comprises a projector module operably coupled to the processing circuitry to generate a display on a surface at or near the workstation at which the work tool is operated.

12. The work system of claim 11, wherein the projector module comprises a projector bulb and is removably operably coupled to the air filtration assembly.

13. The work system of claim 12, wherein the projector module is operably coupled to the housing and generates the display on a floor below the workstation via the projector bulb.

14. The work system of claim 12, wherein the projector module is operably coupled to the housing and generates the display on a work surface of the workstation via the projector bulb.

15. The work system of claim 12, wherein the projector module is disposed at the intake of the air filtration assembly.

16. The work system of claim 15, wherein the projector module generates the display on a work surface of the workstation via the projector bulb.

17. The work system of claim 12, wherein the projector module further comprises an optical sensor.

18. The work system of claim 17, wherein the display is interactive and the optical sensor conveys the user's interactions with the display to the processing circuitry as the control signals.

19. The work system of claim 12, wherein the projector module is customizable to move a location of the display, to adjust a size of the display and to adjust a focus of the projector bulb.

20. The work system of claim 11, wherein the work tool is a soldering tool.
